(19) United States
(12) Patent Application Publication
(10) Pub. No.: US 2025/0292113 A1
(43) Pub. Date: Sep. 18, 2025

(54) GENERATING CUSTOM ACTIONABLE CONTENT ITEMS

(71) Applicant: Read AI, Inc., Seattle, WA (US)

(72) Inventors: Elliott WALDRON, Seattle, WA (US); Robert WILLIAMS, Seattle, WA (US); David SHIM, Seattle, WA (US); Kalle Antti ESKELIN, Wenatchee, WA (US); Lukasz Piotr WOLOSZYN, San Diego, CA (US)

(21) Appl. No.: 18/603,545

(22) Filed: Mar. 13, 2024

(51) Int. Cl. G06N 5/022

(52) U.S. Cl. CPC G06N 5/022

(57) ABSTRACT

A predictive action engine monitors digital content sources within an organization to detect generation or ingestion of digital content by computer systems of the organization. The engine determines one or more entities that are relevant to a user associated with the organization. The engine processes content items obtained from the digital content sources to detect an entity within a digital content item that corresponds to an entity of the one or more entities that are relevant to the user. The engine then generates a custom content item for the user based on the detected entity and at least a portion of the identified digital content item.

### BACKGROUND

Many organizations are experiencing a proliferation of content that is generated, used, and shared both within the organization and with parties outside the organization. Employees of a company, for example, often spend a significant amount of their days managing the flow of this content while keeping up-to-date on tasks and follow-ups. In spite of best efforts to manage the flow of information, information is often not effectively communicated throughout an organization. Employees may miss significant updates that are shared in a meeting to which the employee was not invited, for example, or an employee in one group may not know that another group has developed a resource that would be helpful to the employee.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows an example computing environment and digital content prediction platform in accordance with some implementations of the present technology.

FIG. 1B shows an example computing framework in accordance with some implementations of the present technology.

FIG. 2 illustrates an example of monitoring digital content sources to identify content items and entities with which users interact, in accordance with some implementations of the present technology.

FIG. 3A illustrates generating user relevant entities, in accordance with some implementations of the present technology.

FIG. 3B illustrates identifying content items that contain entities relevant to a target user, in accordance with some implementations of the present technology.

FIG. 3C illustrates another process for identifying content items that contain entities relevant to a target user, in accordance with some implementations of the present technology.

FIG. 3D illustrates generating a custom digital content item, in accordance with some implementations of the present technology.

FIG. 4 illustrates an example process for predicting a relevant digital content item type based on a timeline of digital content items referenced by users, in accordance with some implementations of the present technology.

FIG. 5 is a flowchart illustrating a process for generating a custom digital content item for an end user, in accordance with some implementations of the present technology.

FIG. 6 is a flowchart illustrating a process for identifying user relevant entities for an end user based on user interactions with digital content items, in accordance with some implementations of the present technology.

FIG. 7 is a flowchart illustrating a process for generating a custom digital content item for an end user based on processed digital content items, in accordance with some implementations of the present technology.

FIG. 8 is a flowchart illustrating a process for predicting a new user relevant digital content entity based on existing user relevant entities and digital content items, in accordance with some implementations of the present technology.

FIG. 9 illustrates a layered architecture of an artificial intelligence (AI) system that can implement machine learning models, in accordance with some implementations of the present technology.

FIG. 10 is a block diagram of a transformer neural network, which may be used in examples of the present disclosure.

FIG. 11 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

To improve information flow in an organization, a predictive action engine generates custom content items for users in the organization based on other content items. According to some implementations, the predictive action engine that is communicatively coupled to digital content sources within an organization monitors these digital content sources. Monitoring these sources can include detecting generation or ingestion of digital content by computer systems of the organization. One or more entities that are relevant to a user associated with the organization can be determined. The predictive action engine processes content items obtained from the digital content sources to detect an entity within a digital content item that corresponds to an entity of the one or more entities that are relevant to the user, and generates a custom content item for the user based on the detected entity and at least a portion of the identified digital content item.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Digital Content Prediction Platform

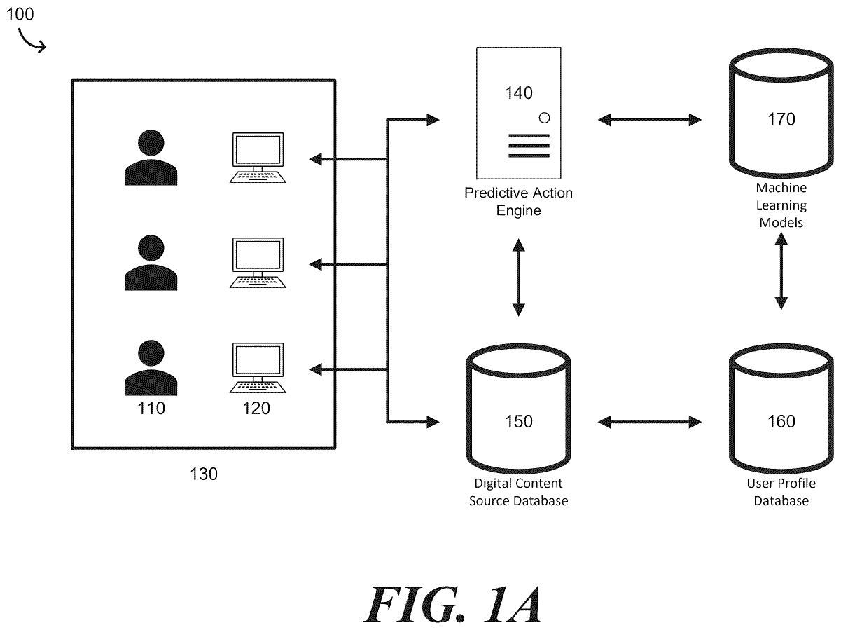

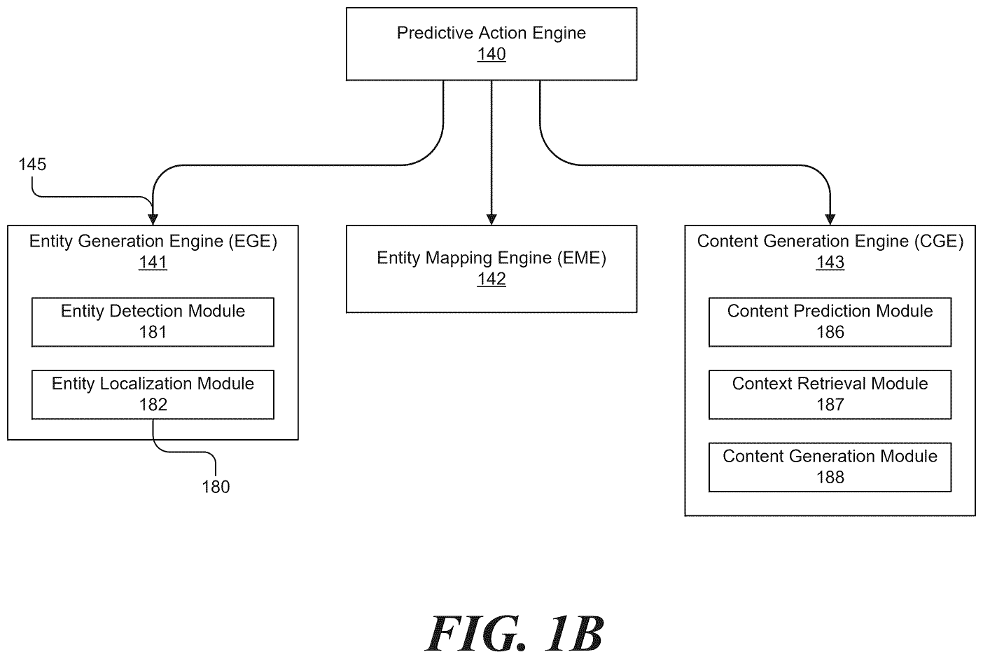

FIG. 1A shows an example computing environment and digital content prediction platform in accordance with some implementations of the present technology. As shown, the environment 100 includes an organization 130 of end user(s) 110, each with a respective user interface 120; a predictive action engine 140; and one or more of a database storage system 150, 160, 170. The one or more data storage systems 150, 160, 170 comprise a digital content source database 150, a user profile database 160, and a machine learning (ML) model storage database 170. These systems can be communicatively coupled to the digital content prediction platform via a public or private network, such as the Internet or one or more local area networks. Each of the predictive action engine 140 and database storage systems 150, 160, 170 can each include various components, including one or more processors, memory modules, transceivers, network interfaces, databases, executable files (in binary form and/or in compiled form), libraries of executables, file structures and so forth.

The organization 130 of end users 110 includes a group of people or systems that communicate, share information, and/or generate content. Although some aspects are described herein with respect to a business as an example type of organization, the organization 130 can be any of a variety of organization types, including, for example, educational institutions, governmental bodies, clubs, social groups, or groups organized temporarily for a given purpose (e.g., a task force). The organization 130 can also include subsets of these organization types or multiple organizations and types of organizations.

In some implementations, any of the user interface 120, predictive action engine 140, and database storage systems 150, 160, 170 can be distributed across more than one computing devices. For example, a particular instance of the digital content prediction platform can be deployed as an executable environment available in a cloud-based environment, such as, for example, in a virtual private cloud, via a virtual network, in DaaS (data-as a service) computing environment, Saas (software-as-a-service) computing environment, PaaS (platform-as-a-service) computing environment), IaaS (infrastructure-as-a-service computing environment) and/or the like. Accordingly, the executable environment can be deployed as a container, pod of containers, cluster of containers, or a dedicated computing grid in a cloud-based environment, which provide varying levels of process and data isolation to meet various levels of data privacy and regulatory standards. At a minimum, the cloud-based implementation infrastructure described herein allows (at the container level) for isolating API calls and data workflows, which secures and isolates data streams and data stores.

As shown, the digital content prediction platform includes various engines, some of which can be omitted or combined according to various implementations. As used herein, the term “engine” refers to one or more sets of computer-executable instructions, in compiled or executable form, that are stored on non-transitory computer-readable media and can be executed by one or more processors to perform software- and/or hardware-based computer operations. The computer-executable instructions can be special-purpose computer-executable instructions to perform a specific set of operations as defined by parametrized functions, specific configuration settings, special-purpose code, and/or the like. The engines can generate and/or receive various electronic messages (e.g., via channels). Whenever a particular message is referred to in singular form, one of skill will appreciate that more than one electronic messages can be used to carry out the described operations. For example, a particular dataset, record, or item therein can be broken down into multiple messages. Furthermore, a particular system or module can generate or receive multiple items (e.g., datasets, records, and/or items) in a particular message.

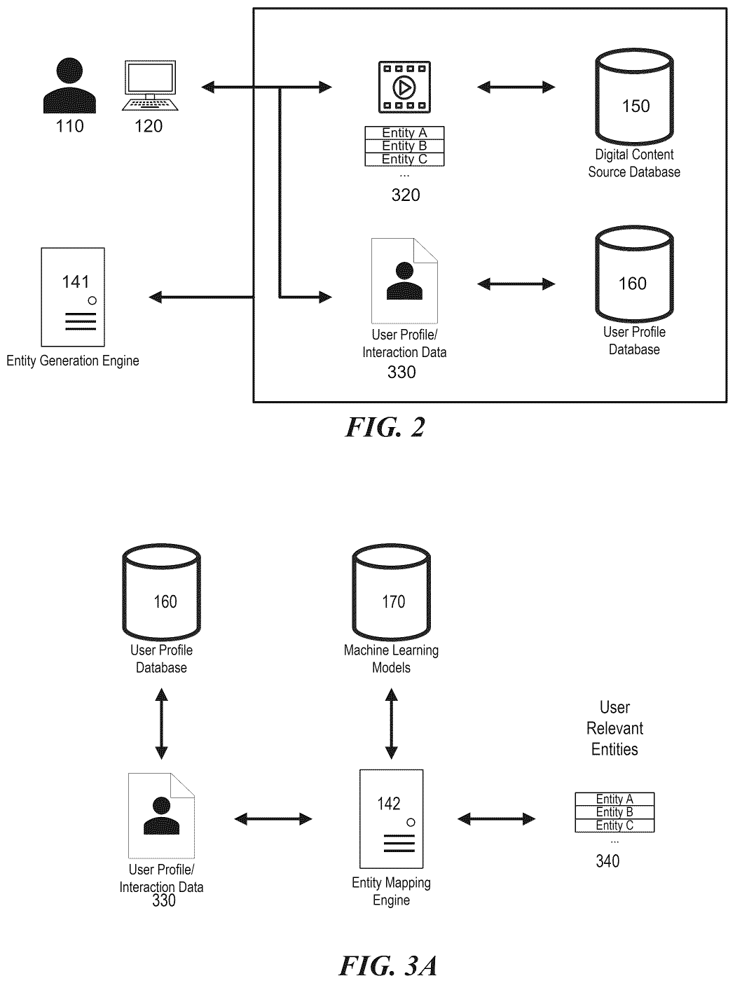

The digital content prediction platform includes a predictive action engine 140 that is communicatively coupled to user devices used by the end users 110. The predictive action engine 140 intelligently generates custom content items for the end users 110 based on other content items associated with the organization 130. The engine 140 determines entities that are relevant to a user and generates custom content items that relate to these user relevant entities. Custom content items generated by the predictive action engine 140 can include any of a variety of types of content items that separate relevant information from irrelevant information, anticipate tasks that would be performed by a user, reduce burden on a user to find and track relevant information, or otherwise improve the management of digital content within an organization to usefully automate tasks for users. The custom content items can be generated based in part on other content items within the organization 130. A process for deriving user relevant entities and generating custom content items is described with respect to FIGS. 2-8.

Entities analyzed by the predictive action engine 140 to generate custom content items can include any topics or concepts that are relevant to a user's activities in the organization 130 such as projects, sub-tasks within projects, action items, key questions, or themes. Entities can be specific objects created during the course of the organization's activities (such as names of projects or action items), or can represent semantic clusters derived from content items in the organization (such as the concept of “leadership skills”). For example, a user who performs marketing tasks for various clients may find the following entities relevant to their work: an overall relationship with Client A, a marketing project for Client A, an action item for the marketing project for Client A, the topic of “general marketing skills,” and the topic of “trends within Client A's industry.”

The predictive action engine 140 can detect user interactions with content and output content to the end users 110 via the user interfaces 120. The predictive action engine 140 can be configured to detect user actions on the user interface 120. For example, predictive action engine 140 can monitor instances of the user 110 selecting a digital content item from the digital content source database 150. In additional or alternative implementations, the predictive action engine 140 can record the detected user actions onto the user profile database 160. In some implementations, the predictive action engine 140 can communicate directly with the digital content source database 150, the user profile database 160, and/or the machine learning model database 170. For example, the predictive action engine 140 can display a set of digital content items on the user interface 120 that was retrieved from the digital content source database 150 and/or generated by the predictive action engine 140.

The one or more data storage systems includes the digital content source database 150 that is connected to the user interface 120, the predictive action engine 140, and/or the user profile database 160. The digital content source database 150 can be configured to store digital content data accessed by the end users 110 and used by the predictive action engine 140. For example, the digital content source database 150 can store digital content items created by an end user 110, custom digital content items generated by the predictive action engine 140, and/or user relevant entities associated with stored digital content items and accessible to the predictive action engine 140 and the user interface 120. In additional or alternative implementations, the digital content database 150 can access the machine learning model database 170 and can serve as an information link between the one or more database storage systems, the predictive action engine 140, and/or the machine learning model database 170. For example, the digital content source database 150 can provide the predictive action engine 140 access to model output data (e.g., custom generated digital content items) generated using ML models from the machine learning model database 170. The digital content items stored in the database 150 can include any of a variety of types of content items generated or ingested into the organization 130, including documents, slide decks, video or audio recordings of meetings, transcripts of meeting recordings, electronic communications between users (e.g., emails or instant messages), or tickets generated within project tracking applications.

The one or more database storage systems include the user profile database 160 that is connected to the predictive action engine 140, the digital content source database 150, and the machine learning model database 170. The user profile database 160 can be configured to store critical user information frequently used by the predictive action engine 140 (e.g., and also interchangeably between database storage systems). For example, the user profile database 160 can store user profile information, previous user interaction history with digital content items from the digital content source database 150, and/or digital content entities that are relevant to one or more users and is accessible to the predictive action engine 140 and the digital content source database 150. In additional or alternative implementations, the user profile database 160 can access the machine learning model database 170 and can serve as an information link between the one or more database storage systems, the predictive action engine 140, and/or the machine learning model database 170. For example, the user profile database 160 can provide the predictive action engine 140 access to model output data (e.g., user relevant entities) generated using ML models from the machine learning model database 170.

The one or more database storage systems include the machine learning model database 170 that is connected to the predictive action engine 140, the digital content source database 150, and/or the user profile database 160. The machine learning model database 170 can be configured to store executable machine learning models used by the predictive action engine 140. For example, the predictive action engine 140 can use an ML model stored in the machine learning model database 170 to generate custom digital content items and/or identify user relevant entities associated with digital content items. In other implementations, the machine learning model database 170 can be configured to store executable programs and/or scripts with instructions to train or update the executable machine learning models.

FIG. 1B shows an example computing framework in accordance with some implementations of the present technology. As shown, the predictive action engine 140 comprises one or more computation engines 145 including an entity generation engine 141, an entity mapping engine 142, and a content generation engine 143, each with a respective set of functional modules 180 for performing one or more computations in accordance with some implementations of the present technology.

Some implementations of the predictive action engine 140 enable the one or more computation engines 145 to be implemented on a single computational server. In additional or alternative implementations, the predictive action engine 140 enables implementation of each computation engine in the one or more computation engines 145 on separate computational servers that are interconnected via a communication service (e.g., telecommunication network). In some implementations, the predictive action engine 140 enables each computation engine 145 to receive instructions from a central computational server. For example, the predictive action engine 140 can execute a central logic on the central computational server for a data pipeline comprising a specified order of processing data from one or more functionality modules 180 from a specified computation engine 145. In additional or alternative implementations, the predictive action engine 140 enables each computation engine to function as independent computational servers (e.g., serverless computation function) of other computation engines. For example, the predictive action engine 140 can configure a first functionality module 180 of a first computation engine 145 to process data upon receiving a signal (e.g., receipt of input data) from a second functionality module 180 from a second computation engine 145.

The entity generation engine 141 detects entities within content items associated with the organization. Entities can include, for example, unanswered questions in a meeting transcript, action items in an instant messaging or email conversation, prospective clients derived from a meeting invite, topics derived from semantic clusters of content items, or workstreams derived from repeated mentions of topics over time. As shown in FIG. 1B, the entity generation engine 141 comprises an entity detection module 181, an entity localization module 182, and an entity summarization module 183.

The entity detection module 181 can enable the entity generation engine 141 to monitor and detect a target entity found in a digital content item. For example, the entity detection module 181 can search for the target entity (e.g., an action item for a user) within the digital content item (e.g., an email). In some implementations, the entity detection module 181 can perform the search for the target entity in the content item using a machine learning model (e.g., a large language model) from the machine learning model database 170. For example, the entity detection module 181 can process the digital content item via the machine learning model to generate an indication of the target entity. In some implementations, the indication of the target entity can comprise a confidence measure for identifying the target content item entity in the set of content item entities.

The entity localization module 182 can enable the entity generation engine 141 to identify a specific location of a target entity within a digital content item. For example, the entity localization module 182 can search a set of entities (e.g., an ordered sequence of action items) corresponding to the digital content item to identify a current location (e.g., a timestamp) of the target entity in the content item. In additional or alternative implementations, the entity localization module 182 can provide a range of locations (e.g., a time duration) comprising current locations of the target entity in the content item.

In some implementations, the entity localization module 182 can perform the identification of a specific location of a target entity within a digital content item using a machine learning model (e.g., a large language model) from the machine learning model database 170. For example, the entity localization module 182 can process the set of entities associated with the digital content item via the machine learning model to generate one or more estimated locations of the target entity in the content item. In some implementations, the indication of the target content item can comprise a confidence measure for identifying the location of the target entity in the content item.

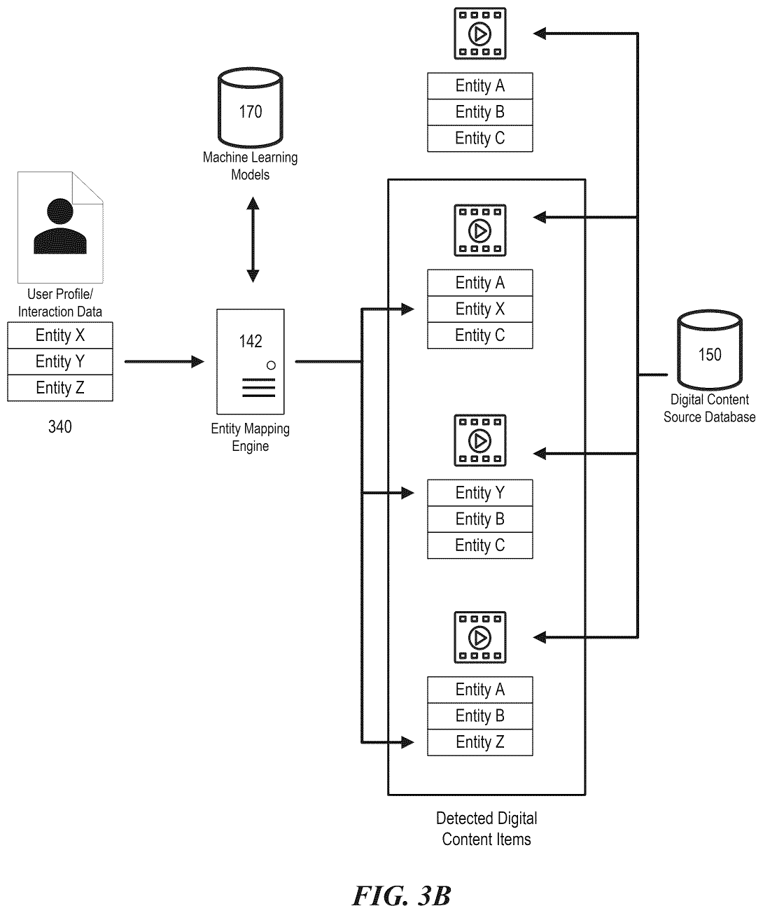

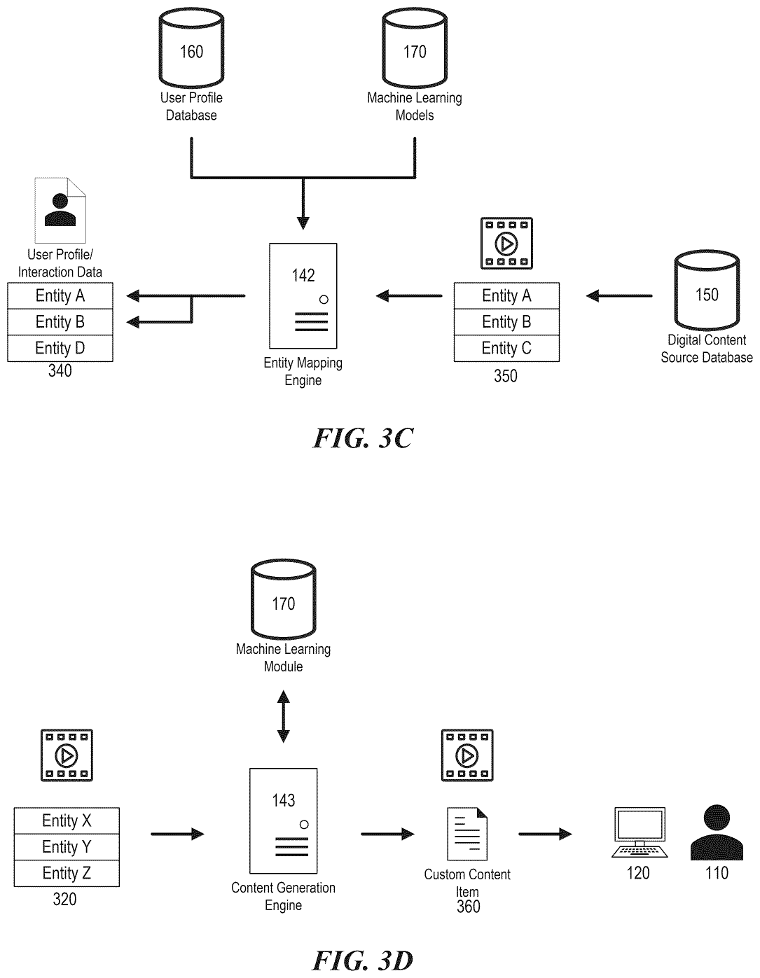

The entity mapping engine 142 determines entities that are relevant to a particular user within an organization. Some entities can be determined to be relevant to a user based on the user's interactions with content items that contain or relate to those entities. Users can also explicitly identify entities that are relevant to themselves or to other users. Example processes for identifying user-relevant entities are described with respect to FIGS. 3A-3C.

The content generation engine 143 generates custom content items for users based on user relevant entities and the content items in the organization that contain these user relevant entities. Custom content items generated by the content generation engine 143 can include, for example, a daily summary of topics of interest to a user, a slideshow presentation of a quarterly business review for a client one week after each quarter ends, a meeting invite based on an action item, a product requirements document based on a workstream, a calendar update with a note to make a user optional for a meeting they often miss, or a Slack message to another user with a hyperlink to a moment in a meeting where that user's work was discussed. As shown in FIG. 1B, the content generation engine 143 comprises a content prediction module 186, a context retrieval module 187, and a content generation module 188.

The content prediction module 186 can enable the content generation engine 143 to estimate a probability measure that a target content item will appear in a future sequence of digital content items. For example, the content prediction module 186 can receive a target content item (e.g., a meeting summary) and a set of past sequences (e.g., a time ordered series of action items) of digital content items to determine a likelihood that the target content item will occur in the future sequence of a current sequence of digital content items. In additional or alternative implementations, the content prediction module 186 can predict an estimated location of the target content item in the future sequence of digital content items.

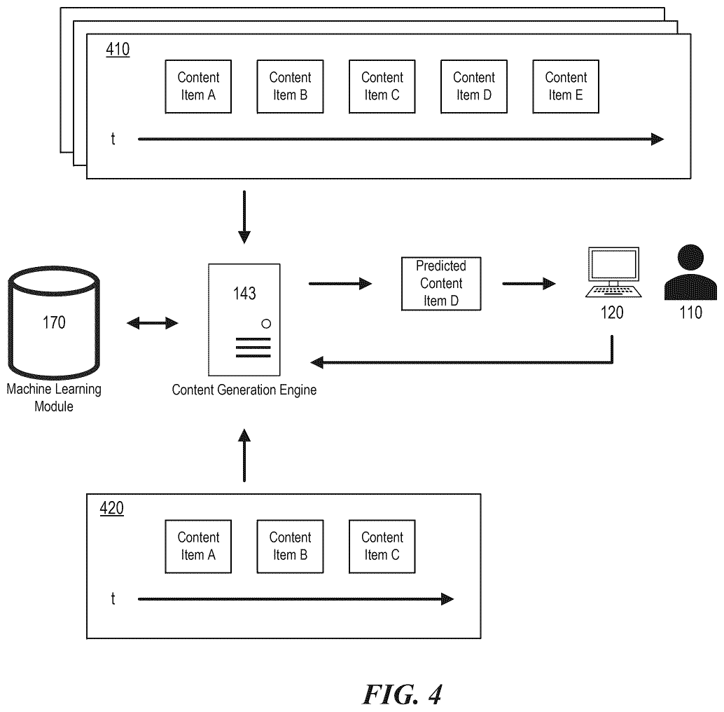

In some implementations, the content prediction module 186 can perform the estimation of a probability measure that a target content item will appear in a future sequence of digital content items using a machine learning model (e.g., a large language model) from the machine learning model database 170. For example, the content prediction module 186 can process the target content item and the set of past sequences of digital content items to generate an estimated likelihood that the target content item will occur in the future sequence of a current sequence of digital content items. A process for predicting a next content item that will occur in a sequence of content items is described further with respect to FIG. 4.

The context retrieval module 187 can receive the predicted digital content item (e.g., a meeting summary) from the content prediction module 186 to identify one or more entities (e.g., recent meeting transcripts, action items, topic questions) corresponding to the predicted digital content item from the digital content source database 150.

In some implementations, the context retrieval module 187 can perform the retrieval of a set of entities relevant to a predicted digital content item using a machine learning model (e.g., a large language model) from the machine learning model database 170. For example, context retrieval module 187 can process the predicted digital content item from the content prediction module 186 to identify one or more entities corresponding to the predicted digital content item from the digital content source database 150. In some implementations, the context retrieval module 187 can produce a mapping between each entity in the one or more entities to a likelihood measure that the entity is relevant to the predicted digital content item.

The content generation module 188 can enable the content generation engine 143 to generate the predicted digital content item. For example, the content generation module 188 can receive the set of content item entities relevant to the predicted digital item from the context retrieval module 187 to generate a new digital content item that is stored in the digital content source database 150. In additional or alternative implementations, the content generation module 188 can append the new digital content item onto a future sequence of digital content items.

In some implementations, the content generation module 188 can perform the generation of the predicted digital content item using a machine learning model (e.g., a large language model) from the machine learning model database 170. For example, the content generation module 188 can process the set of content item entities relevant to the predicted digital item from the context retrieval module 187 to generate a new digital content item that is stored in the digital content source database 150. A process for generating custom content items is described with respect to FIG. 3D.

### Generating Custom Digital Content Items Based on Relevant Entities

As described above, the predictive action engine 140 generates custom content items for users of an organization based on other content items associated with the organization and based on a determination of entities that are relevant to the users. Generally, the predictive action engine 140 determines entities that are relevant to a user, identifies when an action in the organization (e.g., creation or modification of a content item) relates to one or more of the user relevant entities, and generates a custom content item for the user based on the related user relevant entities and the action in the organization.

FIG. 2 illustrates an example of monitoring digital content sources to identify content items and entities with which users interact, in accordance with some implementations of the present technology. The entity generation engine 141 can monitor user interactions with content items to, for example, determine entities that are relevant to a particular user, determine content item types that are relevant to a user, or to improve any of the machine learning models 170 used by the engine. The entity generation engine 141 can monitor user interactions with content items by detecting user interactions via the user interface 120 with digital content items 320 from the digital content source database 150, such as viewing content items, creating content items, modifying content items, or sharing content items. Interactions can also be detected by accessing network communication data between the user interface 120 and the digital content source database 150. Additionally or alternatively, the entity generation engine 141 can monitor generation and subsequent upload of digital content by the user 110 to the digital content source database 150 or can monitor ingestion of digital content items 320 from the digital content source database 150 to the user interface 120. In additional or alternative implementations, the entity generation engine 141 can perform the aforementioned and following described implementations using the entity detection module 181, the entity localization module 182, the entity summarization module 183, and/or any combination thereof.

Some implementations of the entity generation engine 141 identify content items with which a user has interacted by identifying user specific meta data associated with each user 110 interaction on the user interface 120 with the digital content source database 150. For example, the entity generation engine 141 can identify user information 330 (e.g., user profile data, user preferences, user digital content history, user created digital content items, etc.) associated with the user 110 from the user profile database 160. In additional or alternative implementations, the entity generation engine 141 can use the identified user information 330 to filter digital content items 320 from the digital content source database 150. For example, the entity generation engine 141 can use user information 330 corresponding to a user 110 to identify a set of digital content items 320 that appeal to preferences or needs of the user 110.

In additional or alternative implementations, the digital content items 320 stored on the digital content source database 150 can include user meta data with corresponding user information 330 in the user profile database 160. For example, each digital content item 320 can include a set of users that have accessed the digital content item 320, a user that initially generated the digital content item 320, a set of users that have permission to access the digital content item 320, and/or any combination thereof. In additional or alternative implementations, the digital content items 320 can include user interaction information that records user actions with entities found in each digital content item 320.

The entity mapping engine 142 identifies entities that are relevant to a user. Some relevant entities can be determined based on the detection of user interactions with content items in the content source database 150. An example of generating user relevant entities 340 in accordance with some implementations of the present technology is illustrated in FIG. 3A. In the example illustrated in FIG. 3A, the entity mapping engine 142 can determine a set of user relevant entities 340 (e.g., action items, questions, topics, and/or user defined entities) for a user 110 based on corresponding user interaction data 330 from the user profile database 160, including the digital content items with which the user interacted. In some implementations, the entity mapping engine 142 determines the set of user relevant entities 340 based on common digital content entities found in the digital content items 320 from the digital content source database 150 with which the user interacted.

In some implementations, the entity mapping engine 142 can use a predetermined procedure or automated process for identifying the relevant entities 340 based on the user interaction data 330. For example, the entity mapping engine 142 can search digital content items 320 from the digital content source database 150 for entities found in at least a threshold number or percentage of the content items with which the user has interacted. Other implementations of the entity mapping engine 142 evaluate user activity with digital content items 320 based on specific user interactions with a predefined set of entities. For example, the entity mapping engine 142 determines if the user interacts with digital content items that include or are associated with entities in the predefined set. If a user's interactions with content items that include an entity in the predefined set satisfy a criterion (e.g., the user interacts with a threshold number of content items that include the entity, or the user's interaction time with one or more content items containing the entity is greater than a threshold), the entity mapping engine 142 determines that the entity is relevant to the user. In additional or alternative implementations, the entity mapping engine 142 uses one or more machine learning models from the machine learning model database 170 to identify the relevant entities 340. The machine learning models can include, for example, recommendation models that predict that a first entity is likely to be relevant to the user based on the user's interest in a second entity. Other machine learning models applied by the entity mapping engine 142 can include models that receive, as input, data associated a user's interactions with certain content items and that predict whether the user is likely to be interested in certain entities within these content items based on the input.

In other implementations, the entity mapping engine 142 determines the set of user relevant entities 340 based on user interactions with custom content items. For example, if the entity mapping engine 142 generates a custom content item for the user based on a first entity, the entity mapping engine 142 monitors the user's interaction with the custom item to determine if the user's interactions with the content item satisfy a criterion. Criteria can include, for example, whether the user's view time for the custom content item is greater than a threshold, whether the user makes less than a threshold number of modifications to the custom item, or whether the user shares the item with another user inside or outside the organization. If the user's interaction with the custom content item satisfies the criterion, the predictive action entity mapping engine 142 can determine that the first entity is relevant to the user. This relevance determination can be directly stored in the user's profile as an entity that is relevant to the user. Alternatively, it can be used as training data to update a model used by the predictive action entity mapping engine 142 to evaluate relevancy of entities to the particular user or to similar types of users.

Once the entity mapping engine 142 has determined entities that are relevant to a user, the entity mapping engine 142 monitors actions within the organization to identify actions that relate to the entities relevant to a particular user. For example, the entity mapping engine 142 monitors new content items being added to the organization's content repositories, detects modifications to content items in the repositories, or receives communications related to entities. In some implementations, the entity mapping engine 142 searches for content items that contain certain user relevant entities, even if these content items have not recently been added or modified to the content repositories.

An example process for identifying content items that contain entities relevant to a target user is illustrated in FIG. 3B. As shown in FIG. 3B, the entity mapping engine 142 can use a set of user relevant entities 340 and user profile information 330 of a user 110 to determine digital content items 320 with entities that correspond to entities found in the set of user relevant entities. The entity mapping engine 142 can determine specific digital content item 320 entities that correspond to entities found in the set of user relevant entities. Alternatively, the entity mapping engine 142 can record a set of digital content items 320 that have been determined to include user relevant entities. Likewise, the predictive action entity mapping engine 142 can also record a set of digital content items 320 that have been determined to not include user relevant entities.

Some implementations of the entity mapping engine 142 define a subset of digital content items 320 from the digital content source database 150 to be used for detecting new user relevant entities. For example, the entity mapping engine 142 can use an existing recorded set of digital content items 320 with high frequency of user relevant entities 340 to detect new user relevant entities. A count and/or weight of user relevant entities can be associated with each digital content item 320 from the digital content source database 150. Using the associated counts and/or weights of user relevant entities, the entity mapping engine 142 can create, or update, the set of digital content items 320 with high frequency of user relevant entities. For example, the entity mapping engine 142 can search for digital content items 320 with the highest recorded counts of user relevant entities 340 and add them to the set of digital content items 320 with high frequency of user relevant entities.

The entity mapping engine 142 can process the digital content items 320 to detect user relevant entities after a detected user interaction from a user, or can identify a subset of digital content items 320 to process based on the detected user interaction with a digital content item entity. In other implementations, the entity mapping engine 142 can be set to automatically process digital content items 320 for user relevant entities of a user 110 based on a processing schedule of predetermined frequency or based on a user-defined frequency (e.g., once a day, once a week, only after user interaction, never, etc.). In additional or alternative implementations, the entity mapping engine 142 can use machine learning models (e.g., large language models) from the machine learning model database 170 to process digital content items 320 and identify corresponding user relevant entities.

Another example process for identifying content items that contain entities relevant to a target user is illustrated in FIG. 3C. In the process illustrated in FIG. 3C, the entity mapping engine 142 processes content items as they are added to or modified within the content database 150 to identify content items that contain user relevant entities. When a new content item 350 is added to the content database 150, the entity mapping engine 142 can process the new content item 350 to identify any entities contained within the item 350 and to evaluate whether any of these entities correspond to user relevant entities 340 of a particular user 110. In some implementations, the entity mapping engine 142 can determine specific user relevant entities 340 that correspond to entities found in the new digital content item 350. In additional or alternative implementations, the entity mapping engine 142 can record a set of user relevant entities 340 and/or users 110 that have been determined to include entities of the digital content item 350. Likewise, the entity mapping engine 142 can also record a set of user relevant entities 340 and/or users 110 that have been determined to not include entities of the digital content item 350.

Some implementations the entity mapping engine 142 can record a subset of digital content items 320 with similar digital content entities to a target digital content item. For example, the entity mapping engine 142 can assign a relevancy score for a digital content item 320 with respect to the target digital content item to indicate similarity between entities of the digital content item 320 and the target digital item. The relevancy score can be assigned, for example, by counting the number of similar entities shared between a digital content item and the target digital content item. Using the relevancy scores of digital content items 320, the entity mapping engine 142 can generate a subset of digital content items by adding digital content items with a relevancy score within a specified threshold. In additional or alternative implementations, the entity mapping engine 142 can use the subset of digital content items to determine relevant users and/or relevant user entities for a target digital content item.

FIG. 3D illustrates an example of generating a custom digital content item in accordance with some implementations of the present technology. The content generation engine 143 can generate a custom digital content item 360 based on at least a portion of a digital content item 320 and a set of user relevant entities 340 of the digital content item 320. The custom digital content item 360 can be, for example, a portion of another content item (e.g., a clip from a recorded meeting) or a new item generated based on one or more other content items with relevant entities. In additional or alternative implementations, the content generation engine 143 can perform the aforementioned and following described implementations using the content prediction module 186, content retrieval module 187, content generation module 188, and/or any combination thereof.

The content generation engine 143 can generate the custom digital content item 360 following a predefined procedure and/or process. In some implementations, when a digital content item that contains a user relevant entity is ingested into the organization (such as the new content item 350 illustrated in FIG. 3C), the content generation engine 143 identifies similar entities for the user relevant entity found for the initial digital content item. The content generation engine 143 can then generate a new item based on the initial digital content item and the similar entities. For example, if the initial digital content item contains an update to a project, the content generation engine 143 can add the update to a status tracker for the project, generate an email with next steps for the project, or generate a calendar event for a team to review the project update. In other cases, the content generation engine 143 generates a new entity for the initial digital content item based on user relevant entities not found in the initial digital content item. In additional or alternative implementations, the content generation engine 143 can use one or more machine learning models or large language models (LLMs) from the set of machine learning models 170 to generate the custom digital content item. For example, the content generation engine 143 sends a prompt to an LLM to cause the LLM to generate the custom content item 360 based on the initial digital content item or based on one or more other content items in the organization.

The content item generated by the content generation engine 143 can be a type of content item that is selected by the content generation engine 143 based on rules or models. Some implementations of the content generation engine 143 employ a model that predicts a type of content that will be relevant to a user's workflow, based on other content items that have been accessed or created as part of the workflow or based on the types of entities that are related to the workflow. A process for predicting relevant content types is described with respect to FIG. 4. The content generation engine 143 can also employ rules that cause the content generation engine 143 to generate certain types of content items based on certain triggering events. For example, if a user relevant entity is an action item discussed during a meeting, the content generation engine 143 may apply a rule that causes a reminder for the action item's deadline to be added to applicable users' calendars. Furthermore, users can specify certain types of content items for the content generation engine 143 to generate.

The content generation engine 143 outputs the custom digital content item to the user, which the user can view or interact with via the user interface 120. User interactions with the custom digital content item (such as view duration, changes made to the content item, sharing the content item, etc.) can be detected and stored. Based on detected user activity, the content generation engine 143 can determine a measure of user relevancy for the custom digital content item. In other implementations, the content generation engine 143 can determine a measure of user relevancy for each entity of the initial digital content item to compare with the measure of user relevancy for the custom digital content item. Based on the comparison, the content generation engine 143 can update the set of user relevant entities for the user 110. In additional or alternative implementations, the content generation engine 143 can compare measures of user relevancy to update the machine learning model used to generate the custom digital content item.

### Predicting Relevant Types of Content Items

As described above, some implementations of the content generation engine 143 generate a custom content item by predicting a type of item that is likely to be relevant to a user. FIG. 4 illustrates an example process for predicting a relevant digital content item type based on a timeline of digital content items referenced by users. In additional or alternative implementations, the content generation engine 143 can perform the aforementioned and following described implementations using the content prediction module 186, content retrieval module 187, content generation module 188, and/or any combination thereof.

To generate predictions for relevant content types, the content generation engine 143 can analyze a set of historical timelines 410 that represent different digital content items with which users interact at different stages within a workflow. For example, when a user onboards a new client to the user's business, the user may first conduct an onboarding meeting with the client. Various types of content items may be generated after the meeting, such as emails, notes, action items, or documents. The user may then conduct another meeting with the client, followed by additional emails, documents, or action items before generating a slide presentation. The slide deck for the presentation may then be emailed to the client and another meeting conducted. This sequence of events can be represented in one of the historical timelines 410. Other similar timelines can be generated for projects or for any of a variety of other workflows within an organization. The timelines 410 can be labeled based on the user(s) who were involved in the workflow, the type of activity associated with the workflow, the types of content items or entities related to the workflow, or based on other relevant data.

The content generation engine 143 uses the historical timelines 410 to generate a content type prediction model for predicting a content item that is relevant to a sequence of events, given other types of content items that have been accessed or generated in association with the sequence of events or based on characteristics of the sequence of events. The content type prediction model can include any of a variety of machine learning-based, rule-based, or statistical models. For example, when a new sequence of events is detected, the content generation engine 143 can apply a model that identifies one or more historical timelines that have corresponding event sequences that most closely match the new sequence of events. Once one or more matching timelines have been identified, the content generation engine 143 predicts that the new sequence of events will include a next event that occurs most commonly within the matching timelines. In another example, the content generation engine 143 uses the historical timelines to train a neural network, random forest, or another type of machine learning model. The trained model can be configured to receive, as input, events in a new sequence of events and to generate a prediction of a next item in the sequence based on the input.

The set of historical timelines analyzed by the content generation engine 143 and used to train models can include historical timelines with similar sequences of digital content items, timelines related to similar types of activities, or timelines generated based on similar users' activities (such as users with similar roles in an organization). In additional or alternative implementations, the set of historical timelines can be comprised of historical timelines of the target user 110 or a combination of the target user 110 and other users.

In an example illustrated in FIG. 4, the content generation engine 143 receives a target timeline 420, representing a sequence in which Content Item A, Content Item B, and Content Item C were generated or accessed by a corresponding user. The content generation engine 143 can use the content type prediction model to identify digital content items of the target timeline 420 as a subset of digital content items of one or more historical timelines in the set of historical timelines 410. Alternatively, the content generation engine 143 can identify the specific sequencing of digital content items of the target timeline 420 within one or more historical timelines in the set of historical timelines 410. For example, the content generation engine 143 uses the content type prediction model to determine that the user is likely to next need to generate Content Item D, based for example on a similar sequence of events in the set of historical timelines 410. The content generation engine 143 can generate Content Item D according to processes described with respect to FIGS. 3A-3D. The content generation engine 143 can present the generated content item to the user 110 via the user interface 120.

In some implementations, the content generation engine 143 can monitor user interactions (e.g., view duration, manual user input) with the generated digital content item to evaluate preferences of the individual user, to better determine relevant entities to the user, and/or to improve the model's predictions for the type of content item that is relevant to a given sequence of events. For example, the content generation engine 143 can adjust the set of historical timelines used to predict and/or generate the predicted digital content item based on the detected user interactions. Similarly, the content generation engine 143 can update the models for predicting the relevant content type based on the detected user interactions, such as retraining a machine learning-based prediction model based on the types of content items with which users interact.

### Custom Content Generation Process

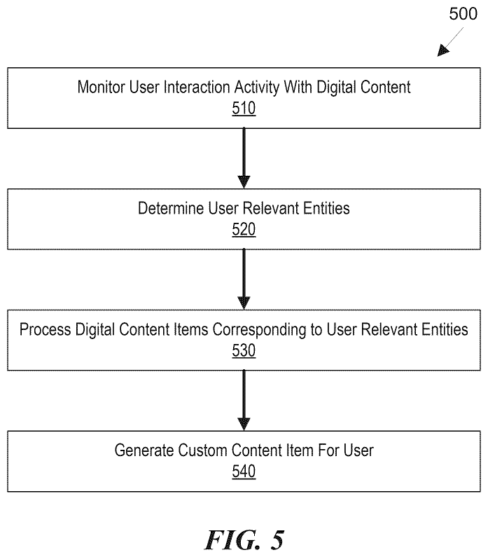

FIG. 5 is a flowchart illustrating an example method 500 of operation of the digital content prediction platform in accordance with some implementations of the present technology. For example, the method 500 can used to generate a custom digital content item for an end user 110. The method 500 can be implemented based on executing instructions stored on the predictive action engine 140 of FIG. 1 and/or one or more of the database storage systems 150, 160, 170 of FIG. 1.

At block 510, the platform monitors user 110 interaction activity with digital content items from the digital content source database 150. For example, the predictive action engine 140 can detect user 110 initiated interactions via the user interface 120 with digital content items found in the digital content source database 150.

At block 520, the platform determines user relevant entities associated with a selected digital content item from the digital content source database 150. For example, the predictive action engine 140 can identify user profile information and previous user interaction history with digital content items in the digital content source database 150 to determine specific user relevant entities (e.g., action items, questions, topics, other user-defined entities) associated with the selected digital content item. In other implementations, the determined user relevant entities can be individual digital content entities, clusters of digital content entities, and/or both.

At block 530, the platform processes digital content items obtained from the digital content source database 150. For example, the predictive action engine 140 can identify one or more digital content entities associated with digital content items retrieved from the digital content source database 150. In some implementations, the predictive action engine 140 can determine a subset of digital content entities in the one or more digital content entities that correspond to a set of user relevant entities associated with an end user 110. In some implementations, the predictive action engine 140 can determine the subset of digital content entities by filtering existing digital content items in the digital content source database 150 based on a provided set of user relevant entities for a user 110. In additional or alternative implementations, the predictive action engine 140 can determine a subset of users and/or user relevant entities by filtering existing user data in the user profile database 160 based on a provided set of digital content item entities.

At block 540, the platform generates a custom digital content item for the user 110. For example, the predictive action engine 140 can generate a custom digital content item for the user 110 based on the determined subset of digital content entities that correspond to the set of user relevant entities and one or more digital content items associated with the subset of digital content entities.

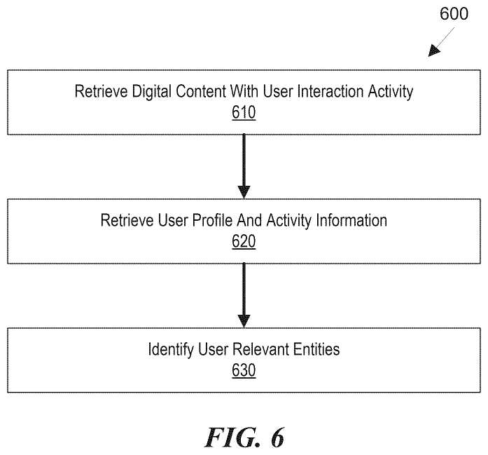

FIG. 6 is a flowchart illustrating an example method 600 of operation of the digital content prediction platform in accordance with some implementations of the present technology. For example, the method 600 can be used to identify user relevant entities for an end user 110 based on user interactions with digital content items from the digital content source database 150 via the user interface 120. The method 600 can be implemented based on executing the instructions stored on the predictive action engine 140 of FIG. 1 and/or one or more of the database storage systems 150, 160, 170 of FIG. 1. The predictive action engine 140 can retrieve relevant digital content items based on monitored user interaction activity, retrieve user profile information from the user profile database 160, and identify the user relevant entities based on processing the retrieved user profile information and monitored user interaction activity.

At block 610, the platform retrieves digital content items from the digital content source database 150 that the user 110 has interacted with via the user interface 120. For example, the predictive action engine 140 can detect digital content items that the user 110 generates and/or ingests from the digital content source database 150. In some implementations, the predictive action engine 140 can record user interaction activity with the detected digital content items to the user profile database 160.

At block 620, the platform retrieves user profile information associated with the user 110 from the user profile database 160. For example, the predictive action engine 140 can access recorded user preference data (e.g., types of digital content entities) and/or user interaction history (e.g., log of digital content items the user interacted with) from the user profile database 160.

At block 630, the platform identifies a set of user relevant entities based on the retrieved user profile information from the user profile database 160. For example, the predictive action engine 140 can use recorded user preference data and/or user interaction history to identify a set of user relevant digital content item entities. In some implementations, the predictive action engine 140 can determine the set of user relevant digital content item entities based on frequency of digital content item entities in the recorded user interaction history. In additional and/or alternative implementations, the predictive action engine 140 can use machine learning models from the machine learning model database 170 to identify the set of user relevant entities based on input user profile information and/or recorded user interaction history data.

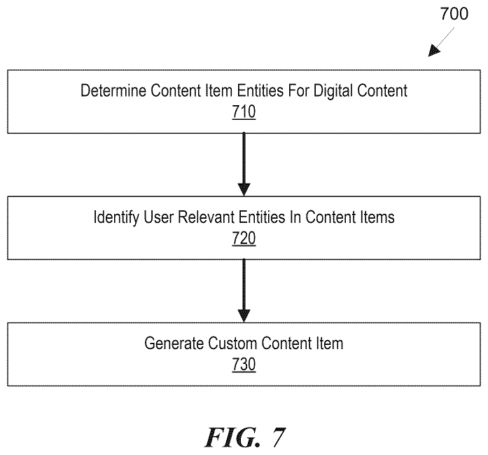

FIG. 7 is a flowchart illustrating an example method 700 of operation of the digital content prediction platform in accordance with some implementations of the present technology. For example, the method 700 can be used to generate a custom digital content item for an end user 110 based on processed digital content items from the digital content source database 150. The method 700 can be implemented based on executing the instructions stored on the predictive action engine 140 of FIG. 1 and/or one or more of the database storage systems 150, 160, 170 of FIG. 1. The predictive action engine 140 can process digital content items from the digital content source database 150 to identify content item entities of the digital content items that are relevant to the end user 110 and generate the custom digital content item.

At block 710, the platform processes one or more digital content items from the digital content source database 150 to determine sets of digital content item entities associated with the one or more digital content items. For example, the predictive action engine 140 can access digital content item entries in the digital content source database 150. In some implementations, each digital content item entry in the digital content source database 150 has at least one associated set of digital content item entities.

At block 720, the platform identifies user relevant entities corresponding to digital content items. For example, the predictive action engine 140 can identify a set of user relevant entities corresponding to a digital content item from the digital content source database 150 based on a comparison between a set of digital content item entities corresponding to the digital content item and a set of user relevant entities associated with a user 110.

At block 730, the platform generates a custom digital content item for the user 110 based on the identified user relevant entities corresponding to digital content items. For example, the predictive action engine 140 can use the identified user relevant entities and at least a portion of the digital content items to generate a new custom digital content item for the user 110. In some implementations, the predictive action engine 140 can use machine learning models from the machine learning model database 170 to generate the custom digital content item using the identified user relevant entities as input data.

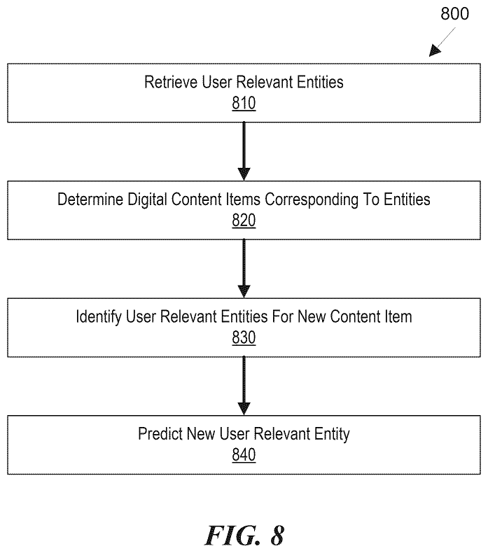

FIG. 8 is a flowchart illustrating an example method 800 of operation of the digital content prediction platform in accordance with some implementations of the present technology. For example, the method 800 can be used to predict a new user relevant digital content entity based on existing user relevant entities and digital content items from the digital content source database 150. The method 800 can be implemented based on executing the instructions stored on the predictive action engine 140 of FIG. 1 and/or one or more of the database storage systems 150, 160, 170 of FIG. 1. The predictive action engine 140 can retrieve user relevant entities from the user profile database 160, determine digital content items from the digital content source database 150 that correspond to the retrieved user relevant entities, identify corresponding user relevant entities found in a new digital content item, and predict the new user relevant entity based on the identified corresponding user relevant entities.

At block 810, the platform retrieves user relevant entities for a user 110 from the user profile database 160. For example, the predictive action engine 140 can retrieve a set of user relevant entities corresponding to at least one digital content item from the digital content source database 150.

At block 820, the platform determines digital content items from the digital content source database 150 that correspond to the retrieved user relevant entities. For example, the predictive action engine 140 can filter one or more digital content items in the digital content source database 150 to determine a set of digital content items that each comprise a set of digital content item entities that satisfy the retrieved user relevant entities.

At block 830, the platform identifies a set of user relevant entities found in a new digital content item. For example, the predictive action engine 140 can determine a set of digital content item entities associated with a new digital content item (e.g., generated digital content items by the platform, uploaded digital content items by users). Using the set of digital content item entities associated with the new digital content item, the predictive action engine 140 can determine a set of user relevant entities that correspond to digital content item entities found in the set of digital content item entities.

At block 840, the platform predicts a new user relevant entity based on the identified set of user relevant entities for the new digital content item. For example, the predictive action engine 140 can compare the identified set of user relevant entities found in the new digital content item to user relevant entities associated with a user profile to predict a new user relevant entity for the new digital content item. In some implementations, the predictive action engine 140 can use machine learning models from the machine learning model database 170 to generate the new user relevant entity for the new digital content item.

### Example Use Cases

In an example use case of the technologies described herein, two users Tim and Sam are discussing a product plan during a one-on-one meeting. Tim inquires if Sam has sought feedback from the engineering team on the plan. The predictive action engine 140, leveraging past data, identifies a clear intention to schedule a meeting and proactively creates a meeting event on the users' calendars. The engine 140 uses contextual information to generate a calendar event that includes the engineering team as attendees, provides a link to the document for review, suggests a suitable meeting time based on maximum predicted engagement, and prompts timely feedback.

In another example, users Pat and Sam, while discussing Ryan's data science project via Slack, conceive a breakthrough idea that could expedite Ryan's work. The predictive action engine 140, trained on past data, identifies when a topic is of high relevance to another user and predicts a high likelihood of a follow-up communication. The system uses the context of the Slack conversation to generate a draft message summarizing the new idea, which is then presented to Sam for potential sharing with Ryan.

Users Ted and Chris, in another example, have weekly one-on-one meetings. Due to Ted's hectic schedule, he often neglects to prepare an agenda, resulting in less productive meetings despite the accumulation of topics, questions, and action items. The predictive action engine 140, learning from past data, identifies that meetings with a predefined agenda are more productive and suggests an agenda for Ted and Chris's upcoming meeting. The engine 140 uses information from the past week's meetings and discussions to generate a draft agenda, which includes action items, key questions, and challenging topics, and sends it to Ted and Chris ahead of their meeting.

Users Tim and Sam are preparing an investor presentation and discussing the company's IP strategy. Meanwhile, the data science team is discussing a novel methodology for summarizing meetings. This new information could enhance Tim and Sam's presentation. The predictive action engine 140, leveraging past data, identifies that having immediate answers to important questions can increase meeting engagement. The engine 140 uses the context of Tim and Sam's discussion to generate a video highlight clip from the data science meeting where the novel methodology was discussed. Tim and Sam are alerted to this clip, which they then incorporate into their presentation.

Sarah and Mike have a meeting with a potential client. During the meeting, the client requests additional information to be sent by the end of the week. Due to their busy schedules, Sarah and Mike forget to send the requested information, potentially jeopardizing the deal. The predictive action engine 140, learning from past data, identifies the need for a follow-up and sets a reminder for the task. The engine 140 uses the context of the meeting to generate a reminder that includes the client's request, the deadline, and potential resources needed to fulfill the request. The reminder is sent to Sarah and Mike two days before the meeting, ensuring they remember to complete the task.

In still another example use case, a marketing team is planning a new campaign. They have a meeting to discuss the need to get the lead designer to develop the image copy. However, due to a lack of communication, the lead designer is out on vacation for the next week. Not knowing this immediately risks delaying the rollout of the new campaign. The predictive action engine 140, leveraging past data, identifies potential resource conflicts by evaluating the relevant calendar schedules and sends alerts to the marketing team after the meeting ends. The system uses the context of the meeting to identify the resource conflict. It then generates a message to the team, highlighting the conflict and recommending the team member who is covering for the lead designer while they are out.

In User Tom's one-on-one with his boss, he says that he is interested in getting more leadership training as he prepares to be considered for a manager role within the product marketing team. His boss is unsure what training programs are available and agrees to look into it. The boss forgets to follow up, creating the potential for Tom to feel he is not being supported in his career goals. The predictive action engine 140, learning from past data, identifies the intent to follow-up and finds similar conversations from other managers. The engine 140 uses the context of the meeting and the related conversations to generate a training resources guide for Tom. It suggests relevant internal and external leadership courses or workshops, and Tom feels supported. The boss also shares this document with his peers, getting kudos from other managers.

During a project planning meeting in another example use case, Jira tasks are assigned to team members. User Sally expresses some confusion about a detail of her assigned task, but fails to speak up given that English is her second language and feels reluctant to expose her lack of understanding. This makes it less likely she meets the team's expectations. The predictive action engine 140, leveraging past data, identifies the potential confusion in her facial expression and voice prosody and drafts a Jira comment to the project lead. The engine 140 uses the context of the meeting and Sally's remarks to generate a draft Jira comment asking for clarification on the key detail. The professional tone of the draft comment helped Sally overcome her reluctance to ask for clarification allowing her to complete the task on time.

During a sales call, a potential client in still another example use case expresses interest in a specific product and requests a detailed proposal. The sales representative, John, is overwhelmed with multiple deals and forgets to draft the proposal, risking the potential sale. The predictive action engine 140, learning from past data, identifies the need for a sales proposal based on the conversation and triggers an action to create a draft proposal. The engine 140 uses the context of the sales call, the client's interest, past proposals and the product details to generate a draft proposal. The proposal includes product specifications, pricing, and the benefits that align with the client's needs expressed during the call. The draft proposal is sent to John for review and customization before sending it to the client. This ensures that the client receives the requested information promptly, improving the chances of closing the sale.

A new employee, Mark, joins another example company and is overwhelmed with the amount of information and processes he needs to learn. His manager, Lisa, is busy with other tasks and is unable to provide Mark with the necessary guidance, causing him to feel lost and unproductive in his first few weeks. The predictive action engine 140, learning from past data, identifies the need for a structured onboarding process and triggers an action to create a personalized onboarding plan for Lisa. The engine 140 uses the context of Lisa's role, department, and the company's past onboarding experiences to generate a comprehensive onboarding plan. This plan includes a schedule of training sessions, introductions to key team members, access to necessary resources, and a checklist of tasks to be completed in the first few weeks. The plan is sent to both Lisa and Mark. This ensures that Lisa feels supported and can quickly become productive, while Mark can monitor her progress without needing to micro-manage her onboarding process.

Over the course of 3 months, another example Company has had several meetings with an important client. The account manager is busy juggling multiple clients and rushes to put the quarterly review slide deck together and misses including a few key points of discussion that came up over the last 3 months. The predictive action engine 140 has learned that ahead of a quarterly business review meeting that a slide deck is sent off to the client one week before the meeting. Using content from the past meetings, a slide deck is generated and made available to the Company. The engine 140 uses the content of these meetings, emails about these meetings, and the shared documents to create a slide deck for the meeting proactively. This can include four steps: the engine 140 (i) recognizing that a slide deck might be needed, (ii) gathering the content for the deck, (iii) instructing a large language model to generate the slide deck, and (iv) proactively suggesting to the user that a document is available.

Still another example user Sarah has conducted numerous customer interviews over the last two weeks where she takes existing customers through a new product feature. Sarah spends many hours reviewing her notes and trying to define the key requirements for this new feature to be successful. The predictive action engine 140 has learned that a product requirements document (PRD) is likely generated after a number of customer interviews have been completed. This triggers the generation of a draft PRD that is made available to Sarah. The system automatically categories calls with the customers and creates a PRD that takes into account the feedback from those customers and delivers it to project managers for review. This can also be pushed into third party platforms like JIRA, Notion, or Salesforce.

In a further use case, a question comes up in one of Tig's sales call that she is unable to answer. Tig says that she will follow up, and in doing so, misses the opportunity to close the ideal during the call. The predictive action engine 140 detects a client question and searches for an answer across similar meetings, emails, as well the companies documentation. The engine 140 delivers the answer to Tig in the real time application, meeting the client's expectations and resulting in a sale.

Finally, users Tom and Brenda are married and often disagree about commitments made in past conversations. This is an enduring source of conflict as they both remember different versions of those past conversations, eventually, resulting in lingering resentment between them. Tom wears augmented reality glasses that are recording important events from the past. In the middle of one discussion about a past commitment, the predictive action engine 140 recognizes that Tom did actually make the commitment. Tom receives a summary of his past statements relating to the commitment from the engine 140 and is able avoid an argument with Brenda.

### Example Machine Learning Architecture

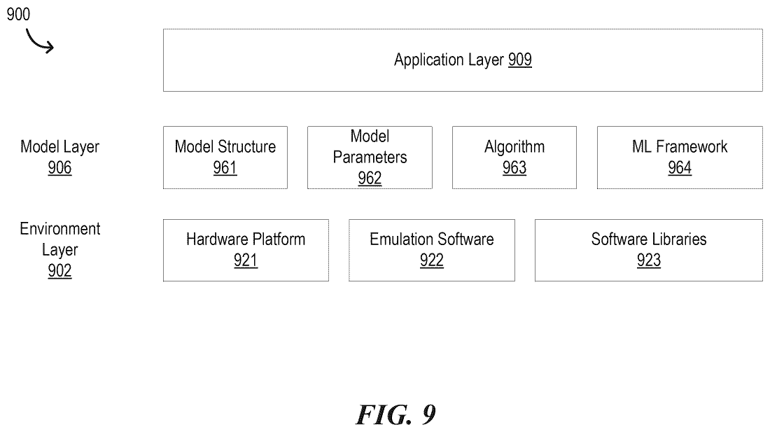

{*** Inventors: the remaining material provides some more basic technical background and boilerplate. No need to review this in detail.***} FIG. 9 illustrates a layered architecture of an artificial intelligence (AI) system 900 that can implement the machine learning models sourced from the machine learning model database 170 of FIG. 1A, in accordance with some implementations of the present technology. For example, the predictive action engine 140 can include some or all elements described in relation to FIG. 9, or can communicate with an AI/ML engine that implements these features.

As shown according to FIG. 9, the AI system 900 can include a set of layers, which conceptually organize elements within an example network topology for the AI system's architecture to implement a particular AI model. Generally, an AI model is a computer-executable program implemented by the AI system 900 that analyzes data to make predictions. In some implementations, the AI model can include various other models, such as neural networks trained to identify entities in pre-processed input data, classify entities in pre-processed input data, identify recurrence and other patterns in pre-processed input data, generate indexes, generate smart variables, generate indicators, and so forth.

In the AI model, information can pass through each layer of the AI system 900 to generate outputs for the AI model. The layers can include an environment layer 902, a model layer 906, and an application layer 909. The model structure 961, the model parameters 962, and the algorithm 963 of the model layer 906 together form an example AI model. The environment layer 902 provides resources and support for application of the AI model by the application layer 909.

The environment layer 902 acts as the foundation of the AI system 900 by preparing data for the AI model. As shown, the environment layer 902 can include three sub-layers: a hardware platform 921, an emulation software 922, and one or more software libraries 923. The hardware platform 921 can be designed to perform operations for the AI model and can include computing resources for storage, memory, logic and networking, such as the resources described in relation to FIG. 1A. The hardware platform 921 can process amounts of data using one or more servers. The servers can perform backend operations such as matrix calculations, parallel calculations, machine learning (ML) training, and the like. Examples of servers used by the hardware platform 921 include central processing units (CPUs), graphics processing units (GPUs), neural processing units (NPUs), and system-on-chips (SoC). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. NPUs are specialized circuits that implement the necessary control and arithmetic logic to execute machine learning algorithms. NPUs can also be referred to as tensor processing units (TPUs), neural network processors (NNPs), intelligence processing units (IPUs), and vision processing units (VPUs). SoCs are IC chips that comprise most or all components found in a functional computer, including an on-chip CPU, volatile and permanent memory interfaces, I/O operations, and a dedicated GPU, within a single microchip. In some instances, the hardware platform 921 can include Infrastructure as a Service (IaaS) resources, which are computing resources (e.g., servers, memory, etc.) offered by a cloud services provider. The hardware platform 921 can also include computer memory for storing data about the AI model, application of the AI model, and training data for the AI model. The computer memory can be a form of random-access memory (RAM), such as dynamic RAM, static RAM, and non-volatile RAM.

The emulation software 922 provides tools for building virtual environments on the hardware platform 921 to simulate operating systems (e.g., Windows, Linux, MacOS, etc.), and their respective protocols, that are not native to the computing system of the hardware platform 921. Thus, emulating operating systems on the hardware platform 921 allows cross-compatible application and deployment of the AI model across multiple devices and computing systems. Examples of emulation software 922 include Docker and VirtualBox.

The software libraries 923 can be thought of as suites of data, programming code, including executables, used to control and optimize the computing resources of the hardware platform 921. The programming code can include low-level primitives (e.g., fundamental language elements) that form the foundation of one or more low-level programming languages, such that servers of the hardware platform 921 can use the low-level primitives to carry out specific operations. The low-level programming languages do not require much, if any, abstraction from a computing resource's instruction set architecture, allowing them to run quickly with a small memory footprint. Examples of software libraries 923 that can be included in the AI system 900 include software libraries Intel Math Kernel Library, Nvidia cuDNN, Eigen, and Open BLAS. The software libraries 923 also feature distribution software, or package managers, that manage dependency software. Distribution software enable version control of individual dependencies and simplified organization of multiple collections of programming code. Examples of distribution software include PyPI and Anaconda.

The model layer 906 can include a model structure 961, model parameters 962, an algorithm 963, and an ML framework 964. The model structure 961 describes the architecture of the AI model of the AI system 900. The model structure 961 defines the complexity of the pattern/relationship that the AI model expresses. Examples of structures that can be used as the model structure 961 include decision trees, support vector machines, regression analyses, Bayesian networks, Gaussian processes, genetic algorithms, and artificial neural networks (or, simply, neural networks). The model structure 961 can include a number of structure layers, a number of nodes (or neurons) at each structure layer, and activation functions of each node. Each node's activation function defines how a node converts data received to data output. The structure layers may include an input layer of nodes that receive input data, an output layer of nodes that produce output data. The model structure 961 may include one or more hidden layers of nodes between the input and output layers. The model structure 961 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 962 represent the relationships learned during training and can be used to make predictions and decisions based on input data. The model parameters 962 can weight and bias the nodes and connections of the model structure 961. For instance, when the model structure 961 is a neural network, the model parameters 962 can weight and bias the nodes in each layer of the neural networks, such that the weights determine the strength of the nodes and the biases determine the thresholds for the activation functions of each node. The model parameters 962, in conjunction with the activation functions of the nodes, determine how input data is transformed into desired outputs. The model parameters 962 can be determined and/or altered during training of the algorithm 963.

The algorithm 963 can be an organized set of computer-executable operations used to generate output data from a set of input data and can be described using pseudocode. The algorithm 963 can include program code that allows the computing resources to learn from new input data and create new/modified outputs based on what was learned. In some implementations, the algorithm 963 can build the AI model through being trained while running computing resources of the hardware platform 921. This training allows the algorithm 963 to make predictions or decisions without being explicitly programmed to do so. Once trained, the algorithm 963 can run at the computing resources as part of the AI model to make predictions or decisions, improve computing resource performance, or perform tasks. The algorithm 963 can be trained using supervised learning, unsupervised learning, semi-supervised learning, self-supervised learning, reinforcement learning, and/or federated learning.

Using supervised learning, the algorithm 963 can be trained to learn patterns (e.g., match input data to output data) based on labeled training data, such as transaction categorization data, entity behavior map data, and so forth.

Supervised learning can involve classification and/or regression. Classification techniques involve teaching the algorithm 963 to identify a category of new observations based on training data and are used when the input data for the algorithm 963 is discrete. Said differently, when learning through classification techniques, the algorithm 963 receives training data labeled with categories (e.g., classes) and determines how features observed in the training data relate to the categories. Once trained, the algorithm 963 can categorize new data by analyzing the new data for features that map to the categories. Examples of classification techniques include boosting, decision tree learning, genetic programming, learning vector quantization, k-nearest neighbor (k-NN) algorithm, and statistical classification.

Federated learning (e.g., collaborative learning) can involve splitting the model training into one or more independent model training sessions, each model training session assigned an independent subset training dataset of the training dataset. The one or more independent model training sessions can each be configured to train a previous instance of the model using the assigned independent subset training dataset for that model training session. After each model training session completes training the model, the algorithm 963 can consolidate the output model, or trained model, of each individual training session into a single output model that updates model. In some implementations, federated learning enables individual model training sessions to operate in individual local environments without requiring exchange of data to other model training sessions or external entities. Accordingly, data visible within a first model training session is not inherently visible to other model training sessions.

Regression techniques involve estimating relationships between independent and dependent variables and are used when input data to the algorithm 963 is continuous. Regression techniques can be used to train the algorithm 963 to predict or forecast relationships between variables. To train the algorithm 963 using regression techniques, a user can select a regression method for estimating the parameters of the model. The user collects and labels training data that is input to the algorithm 963 such that the algorithm 963 is trained to understand the relationship between data features and the dependent variable(s). Once trained, the algorithm 963 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 963 learns patterns from unlabeled training data. In particular, the algorithm 963 is trained to learn hidden patterns and insights of input data, which can be used for data exploration or for generating new data. Here, the algorithm 963 does not have a predefined output, unlike the labels output when the algorithm 963 is trained using supervised learning. Said another way, unsupervised learning is used to train the algorithm 963 to find an underlying structure of a set of data, group the data according to similarities, and represent that set of data in a compressed format.

The model structure 961, parameters 962, and algorithm 963 formally comprise the design, properties, and implementation of an AI model. The structure 961 defines the types of input data used, types of output data produced, and parameters 962 available that can be modified by the algorithm 963. The model parameters 962 are assigned values by the algorithm 963 that determine the characteristics and properties of a specific model state. For example, the algorithm 963 can improve model task performance by adjusting the values of parameters 962 that reduces prediction errors. The algorithm 961 is responsible for processing input data to be compatible with the model structure 961, executing the AI model 318 on available training data, evaluating performance of model output, and adjusting the parameters 962 to reduce model errors. Thus, the model structure 961, parameters 962, and algorithm 963 comprise co-dependent functionalities and are the core components of an AI model.

The ML framework 964 can be thought of as an interface, library, or tool that allows users to build and deploy the AI model. The ML framework 964 can include an open-source library, an application programming interface (API), a gradient-boosting library, an ensemble method, and/or a deep learning toolkit that work with the layers of the AI system to facilitate development of the AI model. For example, the ML framework 964 can distribute processes for application or training of the AI model across multiple resources in the hardware platform 921. The ML framework 964 can also include a set of pre-built components that have the functionality to implement and train the AI model and allow users to use pre-built functions and classes to construct and train the AI model. Thus, the ML framework 964 can be used to facilitate data engineering, development, hyperparameter tuning, testing, and training for the AI model. Examples of ML frameworks 964 that can be used in the AI system 900 include TensorFlow, PyTorch, Scikit-Learn, Scikit-Fuzzy, Keras, Caffe, LightGBM, Random Forest, Fuzzy Logic Toolbox, and Amazon Web Services (AWS).

The ML framework 964 serves as an interface for users to access pre-built AI model components, functions, and tools to build and deploy custom designed AI systems via programming code. For example, user-written programs can execute instructions to incorporate available pre-built structures of common neural network node layers available in the ML framework 964 into the design and deployment of a custom AI model. In other implementations, the ML framework 964 is hosted on cloud computing platforms offering modular machine learning services that users can modify, execute, and combine with other web services. Examples of cloud machine learning interfaces include AWS SageMaker and Google Compute Engine. In other implementations, the ML framework 964 also serves as a library of pre-built model algorithms 963, structures 961, and trained parameters 962 with predefined input and output variables that allow users to combine and build on top of existing AI models. Examples of ML frameworks 964 with pretrained models include Ultralytics and MMLab.

The application layer 909 describes how the AI system 900 is used to solve problem or perform tasks. In an example implementation, the application layer 909 can include a connection to the predictive action engine 140, and subsequently to the user interface 120 of FIG. 1A. For example, the predictive action engine 140 can generate custom digital content items to present to the user interface 120 that is based on model outputs.

Some implementations described herein employ one or more large language models (LLMs) to generate custom content items. These LLMs can include any commercially available or custom models or a set or ensemble of two or more models. Example features of LLMs are now described. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

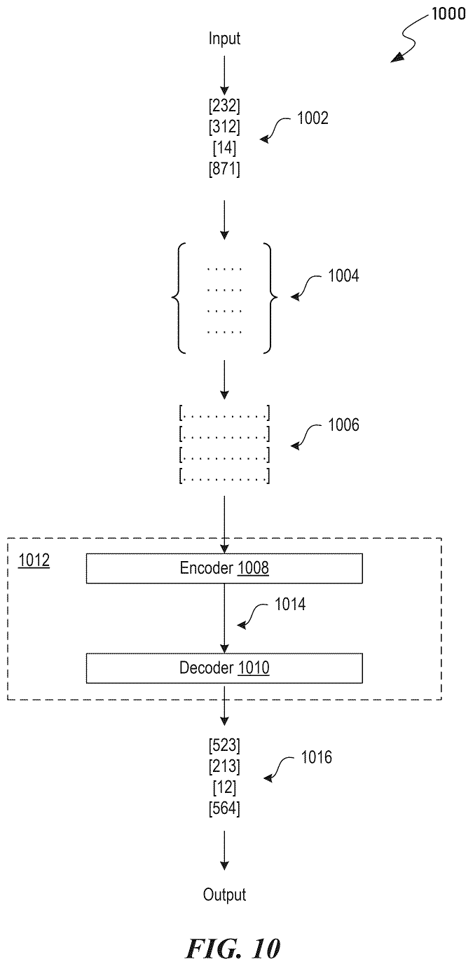

FIG. 10 is a block diagram of an example transformer 1012. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 1012 includes an encoder 1008 (which can include one or more encoder layers/blocks connected in series) and a decoder 1010 (which can include one or more decoder layers/blocks connected in series). Generally, the encoder 1008 and the decoder 1010 each include multiple neural network layers, at least one of which can be a self-attention layer. The parameters of the neural network layers can be referred to as the parameters of the language model.

The transformer 1012 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 1012 is trained to perform certain functions on other input formats than natural language input. For example, the input can include objects, images, audio content, or video content, or a combination thereof.

The transformer 1012 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 10 illustrates an example of how the transformer 1012 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 10, a short sequence of tokens 1002 corresponding to the input text is illustrated as input to the transformer 1012. Tokenization of the text sequence into the tokens 1002 can be performed by some pre-processing tokenization module such as, for example, a byte-pair encoding tokenizer (the “pre” referring to the tokenization occurring prior to the processing of the tokenized input by the LLM), which is not shown in FIG. 10 for brevity. In general, the token sequence that is inputted to the transformer 1012 can be of any length up to a maximum length defined based on the dimensions of the transformer 1012. Each token 1002 in the token sequence is converted into an embedding vector 1006 (also referred to as “embedding 1006”).

An embedding 1006 is a learned numerical representation (such as, for example, a vector) of a token that captures some semantic meaning of the text segment represented by the token 1002. The embedding 1006 represents the text segment corresponding to the token 1002 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1006 corresponding to the “write” token will be closer to another embedding corresponding to the “jot down” token in the vector space as compared to the distance between the embedding 1006 corresponding to the “write” token and another embedding corresponding to the “summary” token.

The vector space can be defined by the dimensions and values of the embedding vectors. Various techniques can be used to convert a token 1002 to an embedding 1006. For example, another trained ML model can be used to convert the token 1002 into an embedding 1006. In particular, another trained ML model can be used to convert the token 1002 into an embedding 1006 in a way that encodes additional information into the embedding 1006 (e.g., a trained ML model can encode positional information about the position of the token 1002 in the text sequence into the embedding 1006). In some implementations, the numerical value of the token 1002 can be used to look up the corresponding embedding in an embedding matrix 1004, which can be learned during training of the transformer 1012.

The generated embeddings 1006 are input into the encoder 1008. The encoder 1008 serves to encode the embeddings 1006 into feature vectors 1014 that represent the latent features of the embeddings 1006. The encoder 1008 can encode positional information (i.e., information about the sequence of the input) in the feature vectors 1014. The feature vectors 1014 can have very high dimensionality (e.g., on the order of thousands or tens of thousands), with each element in a feature vector 1014 corresponding to a respective feature. The numerical weight of each element in a feature vector 1014 represents the importance of the corresponding feature. The space of all possible feature vectors 1014 that can be generated by the encoder 1008 can be referred to as a latent space or feature space.

Conceptually, the decoder 1010 is designed to map the features represented by the feature vectors 1014 into meaningful output, which can depend on the task that was assigned to the transformer 1012. For example, if the transformer 1012 is used for a translation task, the decoder 1010 can map the feature vectors 1014 into text output in a target language different from the language of the original tokens 1002. Generally, in a generative language model, the decoder 1010 serves to decode the feature vectors 1014 into a sequence of tokens. The decoder 1010 can generate output tokens 1016 one by one. Each output token 1016 can be fed back as input to the decoder 1010 in order to generate the next output token 1016. By feeding back the generated output and applying self-attention, the decoder 1010 can generate a sequence of output tokens 1016 that has sequential meaning (e.g., the resulting output text sequence is understandable as a sentence and obeys grammatical rules). The decoder 1010 can generate output tokens 1016 until a special [EOT] token (indicating the end of the text) is generated. The resulting sequence of output tokens 1016 can then be converted to a text sequence in post-processing. For example, each output token 1016 can be an integer number that corresponds to a vocabulary index. By looking up the text segment using the vocabulary index, the text segment corresponding to each output token 1016 can be retrieved, the text segments can be concatenated together, and the final output text sequence can be obtained.

In some implementations, the input provided to the transformer 1012 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

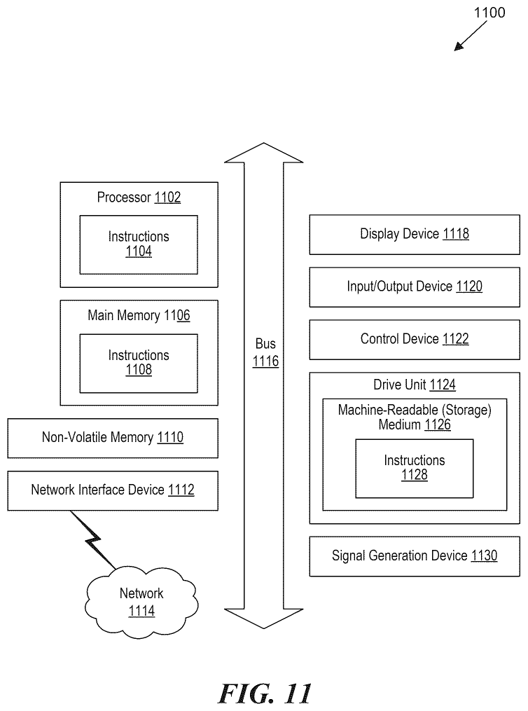

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a display device 1118, an input/output device 1120, a control device 1122 (e.g., keyboard and pointing device), a drive unit 1124 that includes a machine readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the figures and any other components described in this specification can be implemented.

The computer system 1100 can take any suitable physical form. For example, the computer system 1100 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1100. In some implementations, the computer system 1100 can be an embedded computer system, a system-on-chip (SOC), a single-board computer (SBC) system, or a distributed system such as a mesh of computer systems or include one or more cloud components in one or more networks. Where appropriate, one or more computer systems 1100 can perform operations in real time, near real time, or in batch mode.

The network interface device 1112 enables the computer system 1100 to mediate data in a network 1114 with an entity that is external to the computer system 1100 through any communication protocol supported by the computer system 1100 and the external entity. Examples of the network interface device 1112 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable medium 1126 can include any medium that is capable of storing, encoding, or carrying a set of instructions for execution by the computer system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computer system 1100 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A method comprising:
monitoring, by a predictive action engine, digital content sources within an organization,
wherein the predictive action engine is communicatively coupled to the digital content sources; and
wherein monitoring the digital content sources includes detecting generation or ingestion of digital content by computer systems of the organization;
determining, by the predictive action engine, one or more entities that are relevant to a user associated with the organization;
processing, by the predictive action engine, content items obtained from the digital content sources to detect an entity within an identified digital content item that corresponds to an entity of the one or more entities that are relevant to the user; and
generating, by the predictive action engine, a custom content item for the user based on the detected entity and at least a portion of the identified digital content item.

2. The method of claim 1, wherein determining the one or more entities that are relevant to the user comprises:
detecting interactions by the user with digital content items maintained by the organization;
identifying entities associated with the digital content items interacted with by the user; and
selecting one or more of the identified entities as the one or more entities that are relevant to the user.

3. The method of claim 1, wherein determining the one or more entities that are relevant to the user comprises:
detecting an interaction by the user with the custom content item; and
determining the detected entity is relevant to the user based on the interaction with the custom content item.

4. The method of claim 1, wherein generating the custom content item for the user comprises:
modifying one or more of the content items obtained from the digital content sources.

5. The method of claim 1, wherein generating the custom content item for the user comprises:
sending, to a large language model (LLM), a prompt to cause the LLM to generate the custom content item based on:
one or more of the content items obtained from the digital content sources, or
one or more digital content items maintained by the organization.

6. The method of claim 1, wherein generating the custom content item for the user comprises:
applying, to data indicating interactions by the user with digital content items maintained by the organization, a content type prediction model that is trained to generate a prediction for a type of content item that is relevant to the user based on the interactions with the digital content items maintained by the organization;
wherein generating the custom content item comprises generating a content item of the predicted type.

7. The method of claim 6, wherein the content type prediction model is trained based on a set of historical timelines that each include a sequence of content items associated with a workflow, and wherein the content type prediction model is configured to:
receive a timeline of content items accessed by the user; and
generate, as output, the prediction for the type of content item relevant to the user based on the timeline of content items accessed by the user.

8. The method of claim 6, further comprising:
detecting a user interaction with the custom content item; and
retraining the content type prediction model based on the detected user interaction.

9. A non-transitory, computer-readable storage medium comprising instructions recorded thereon, wherein the instructions, when executed by at least one data processor of a system, cause the system to:
monitor digital content sources within an organization,
wherein monitoring the digital content sources includes detecting generation or ingestion of digital content by computer systems of the organization;
determine one or more entities that are relevant to a user associated with the organization;
process content items obtained from the digital content sources to detect an entity within an identified digital content item that corresponds to an entity of the one or more entities that are relevant to the user; and
generate a custom content item for the user based on the detected entity and at least a portion of the identified digital content item.

10. The non-transitory, computer-readable storage medium of claim 9, wherein determining the one or more entities that are relevant to the user comprises:
detecting interactions by the user with digital content items maintained by the organization;
identifying entities associated with the digital content items interacted with by the user; and
selecting one or more of the identified entities as the one or more entities that are relevant to the user.

11. The non-transitory, computer-readable storage medium of claim 9, wherein determining the one or more entities that are relevant to the user comprises:
detecting an interaction by the user with the custom content item; and
determining the detected entity is relevant to the user based on the interaction with the custom content item.

12. The non-transitory, computer-readable storage medium of claim 9, wherein generating the custom content item for the user comprises:
modifying one or more of the content items obtained from the digital content sources.

13. The non-transitory, computer-readable storage medium of claim 9, wherein generating the custom content item for the user comprises:
sending, to a large language model (LLM), a prompt to cause the LLM to generate the custom content item based on:
one or more of the content items obtained from the digital content sources, or
one or more digital content items maintained by the organization.

14. The non-transitory, computer-readable storage medium of claim 9, wherein generating the custom content item for the user comprises:
applying, to data indicating interactions by the user with digital content items maintained by the organization, a content type prediction model that is trained to generate a prediction for a type of content item that is relevant to the user based on the interactions with the digital content items maintained by the organization;
wherein generating the custom content item comprises generating a content item of the predicted type.

15. A system comprising:
at least one hardware processor; and
at least one non-transitory memory storing instructions, which, when executed by the at least one hardware processor, cause the system to:
monitor digital content sources within an organization,
wherein monitoring the digital content sources includes detecting generation or ingestion of digital content by computer systems of the organization;
determine one or more entities that are relevant to a user associated with the organization;
process content items obtained from the digital content sources to detect an entity within an identified digital content item that corresponds to an entity of the one or more entities that are relevant to the user; and
generate a custom content item for the user based on the detected entity and at least a portion of the identified digital content item.

16. The system of claim 15, wherein determining the one or more entities that are relevant to the user comprises:
detecting interactions by the user with digital content items maintained by the organization;
identifying entities associated with the digital content items interacted with by the user; and
selecting one or more of the identified entities as the one or more entities that are relevant to the user.

17. The system of claim 15, wherein determining the one or more entities that are relevant to the user comprises:
detecting an interaction by the user with the custom content item; and
determining the detected entity is relevant to the user based on the interaction with the custom content item.

18. The system of claim 15, wherein generating the custom content item for the user comprises:
modifying one or more of the content items obtained from the digital content sources.

19. The system of claim 15, wherein generating the custom content item for the user comprises:
sending, to a large language model (LLM), a prompt to cause the LLM to generate the custom content item based on:
one or more of the content items obtained from the digital content sources, or
one or more digital content items maintained by the organization.

20. The system of claim 15, wherein generating the custom content item for the user comprises:
applying, to data indicating interactions by the user with digital content items maintained by the organization, a content type prediction model that is trained to generate a prediction for a type of content item that is relevant to the user based on the interactions with the digital content items maintained by the organization;
wherein generating the custom content item comprises generating a content item of the predicted type.
